(19) United States
(12) Patent Application Publication
(10) Pub. No.: US 2005/0211101 A1
(43) Pub. Date: Sep. 29, 2005

(54) Single serving silicone receptacle

(76) Inventor: Richard B. Finnie II, Brea, CA (US)

Correspondence Address: LAW OFFICES OF MARK A. HAMILL, P.C., 45 SOUTH PARK BLVD., SUITE 205, GLEN ELLYN, IL, 60137, US

(21) Appl. No.: 10/806,940

(22) Filed: Mar. 23, 2004

(51) Int. Cl. A21D 10/02

(52) U.S. Cl. 99/279

(57) ABSTRACT

The present invention is directed to an improved receptacle for receipt of a single serving food product comprising, a body portion defining a single serving cavity formed substantially from a silicone rubber material. The body portion includes a substantially planar base portion having a rounded periphery. The base portion also has an inside surface for receipt of food product and an outside surface for contacting a support. The body portion further includes a resilient, substantially annular sidewall portion which extends upwardly and radially outwardly from the rounded periphery of the planar base portion; the annular sidewall portion having an inner surface for receipt of food product.

### FIELD OF THE INVENTION

The present invention is directed to an improved batter receptacle for use in baking cupcakes and/or muffins.

### BACKGROUND

Traditionally, cupcakes are baked in metallic baking trays having a plurality of batter receiving cavities which are each lined with paper liners The paper liners are filled with liquid cupcake batter, and the tray is placed in an oven. Next, the batter is baked, and then the tray is removed from the oven. The cupcake liners are peeled from the cupcake prior to consumption. The paper liner prevents the bottom of the cupcake from sticking to the pan and acts as an insulator to assist in preventing the bottom of the cupcake from burning due to contact with the thermally conductive metallic pan. This is an important function since unlined, metallic baking containers frequently over cook the bottom of baked goods because metal trays are not good thermal insulators. The term “cupcake” is used herein to describe the present invention; however, it is recognized that the invention is equally applicable to the baking of muffins as well as other individual serving, substantially frusto-conical baked goods such as muffin cups and other baking cups. Accordingly, the term “cupcake” as used herein is intended to include cupcakes, muffins and other individual serving, substantially frusto-conical baked goods.

One problem with the current cupcake baking methods is that, even with the use of paper liners, the bottoms of the cupcake are still easier to bum that is desirable. Another problem with the current paper cupcake baking methods is that, when the cupcake is slightly over-cooked, the cupcake can stick to the lining causing the cupcake to crumble more than is desirable. A still further problem with the traditional cupcake baking is that the paper liners are disposable, rather than being reusable or recyclable.

Another problem with traditional cupcake baking methods is that the traditional pans typically contain a fairly limited number of spaced apart cavities for receiving the linings and batter. The pans are designed so that cavities are typically spaced a good distance apart to ensure even baking of each of the cupcakes. As many traditional baking pans stylizes are stamped from metal, their manufacture is simplified if the number and density of the cavities is limited. It would be desirable to have a cupcake baking method and apparatus which allows the baker to maximize the density of cupcakes that may be baked per batch, while at the same time maximizing cupcake quality.

### SUMMARY

In accordance with the present invention, an improved receptacle for receipt of cupcake batter for baking is provided, comprising, a body defining a cupcake batter receiving cavity which is formed substantially from a silicone rubber material. The body includes, a substantially planar base portion having a rounded periphery. The base portion has an inside surface for receipt of cupcake batter and, an outside surface for contacting a support and a rounded periphery. A resilient, substantially annular sidewall portion extends upwardly and radially outwardly from the rounded periphery of the planar base portion. Preferably, the substantially annular sidewall and planar base portion are joined by an angled, comer portion. The use of a silicone rubber material provides the receptacle of the invention with excellent baking properties. Its superior insulating properties inhibit burning of the bottom and sidewalls of the cupcake as well as limit crumbling of the cupcake. Further, its resiliency, flexibility and chemically inert surface provide improved product release compared with paper linings. The use of a silicone rubber also provides a receptacle which may be washed in a standard dishwasher and may be repeatedly reused.

In one embodiment of the invention, the receptacle of the invention may be designed for use as individual liner for insertion into each of a plurality of cavities of a cupcake pan. In this embodiment of the invention, the lining is dimensioned to be received in the cupcake pan cavity which has predetermined bottom and sidewall dimensions. The cupcake liner including: a frusto-conical body formed substantially from a silicone rubber material, the body including, a planar base portion having a rounded periphery and being dimensioned for receipt within batter receiving cavity; and a substantially annular sidewall portion which extends upwardly and radially outwardly from the rounded periphery of the planar base portion. The substantially annular sidewall is dimensioned for receipt within at least a substantial portion of the cavity of the cupcake pan.

In another embodiment of the invention, the receptacle of the invention may be an individual cupcake mold, which comprises: a frusto-conical body formed substantially from a silicone rubber material; the frusto-conical body including, a planar base portion having a rounded periphery, the base portion having an inside surface for receipt of cupcake batter and an outside surface for contacting a support; a resilient, substantially annular sidewall portion which extends upwardly and radially outwardly from the rounded periphery of the planar base portion. Preferably, the substantially annular sidewall and the rounded periphery of the planar base portion are joined at an angled comer portion.

In accordance with one aspect of this embodiment of the invention, a plurality of individual cupcake molds of the invention may be placed on a flat support structure, such as a cookie sheet. Preferably, the cupcake molds are densely packed together. The silicone molds are excellent insulators so that such dense packing will not cause any individual cupcake to overcook. This is in contrast to the situation with thermally conductive metallic cupcake molds when they are tightly spaced. Alternately, a single cupcake or just a few cupcakes may be baked conveniently and efficiently by filling and placing one or more cupcake mold(s) of the invention within a baking oven.

Another embodiment of the invention constitutes an improved method of baking cupcakes which comprises the steps of: filling a resilient, individual cupcake mold formed from a flexible silicone resin with cupcake batter; placing the filled resilient, individual cupcake mold into an oven; baking the cupcake batter within the resilient, individual cupcake mold; removing the resilient individual cupcake mold from the oven; and flexing the resilient individual, cupcake mold to remove the baked cupcake therefrom.

A still further embodiment of the invention includes an improved method of baking a plurality of cupcakes in resilient, silicone cupcake molds, which includes the steps of: filling a plurality of resilient, individual cupcake molds formed from a flexible silicone resin with cupcake batter; placing each of the filled resilient, individual cupcake molds onto a substantially planar support surface; baking the cupcake batter within the plurality of resilient, individual cupcake molds in an oven; removing the plurality of resilient, individual cupcake molds from the oven; and flexing each of the resilient individual, cupcake molds to remove the baked cupcake therefrom. In one preferred embodiment, the method of the invention further includes the steps of densely spacing the plurality of resilient individual cupcake molds onto a planar support surface such that the cupcake molds are adjacent to other of the plurality of resilient individual cupcake molds. In accordance with this preferred method, the number of cupcakes per batch can be maximized without loss of quality in the resulting cupcakes.

### BRIEF DESCRIPTION OF THE DRAWINGS

The organization and manner of the structure and function of the invention, together with the further objects and advantages thereof, may be understood by reference to the following description taken in connection with the accompanying drawings, and in which:

FIG. 1 is a top, plan view of an improved receptacle for receipt of cupcake batter in accordance with one preferred embodiment of the invention;

FIG. 2 is an enlarged cross-sectional view of a portion of the annular side wall of the receptacle indicated by lines 2-2 in FIG. 1;

FIG. 3 is a bottom, plan view of the receptacle of FIG. 1;

FIG. 4 is a side, elevational view of the receptacle of FIG. 1;

FIG. 5 is perspective view of the receptacle of FIG. 1;

FIG. 6 is a side, cross-sectional view of a cupcake liner in accordance with another embodiment of the invention which is located within a cavity in a cupcake pan; and

FIG. 7 is a top, plan view of a plurality of densely spaced cupcake molds in accordance with another embodiment of the invention which are located on a substantially planar support.

### DETAILED DESCRIPTION OF THE ILLUSTRATION EMBODIMENT

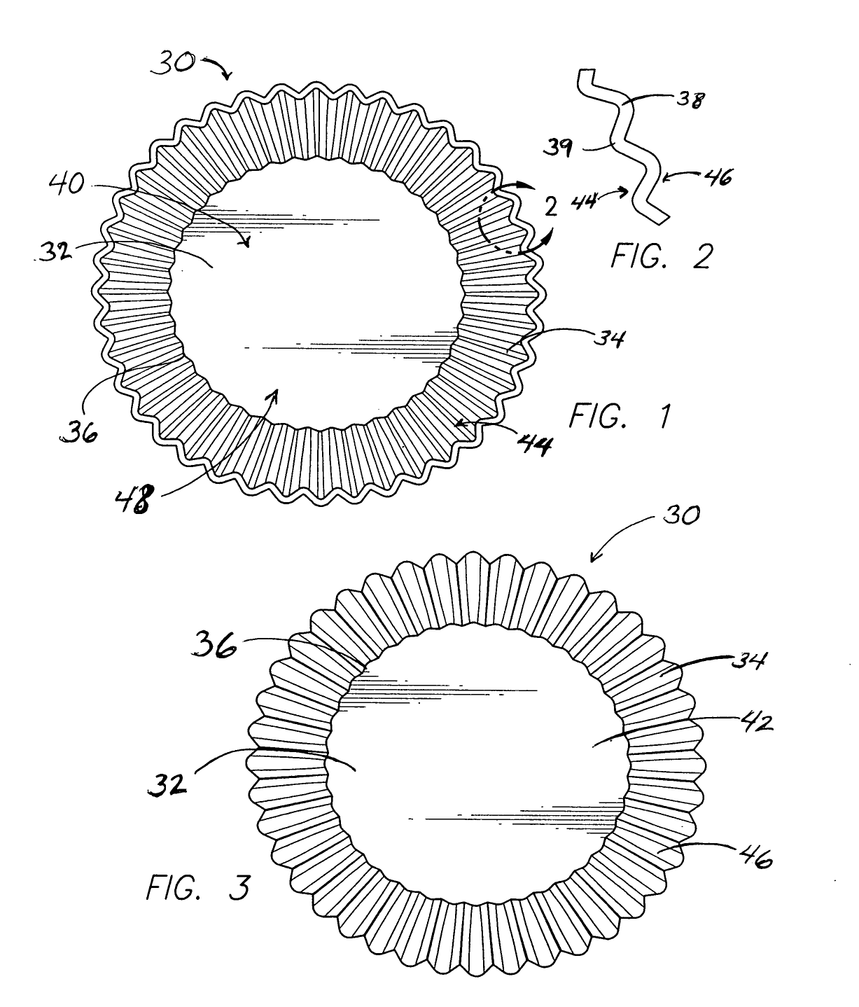

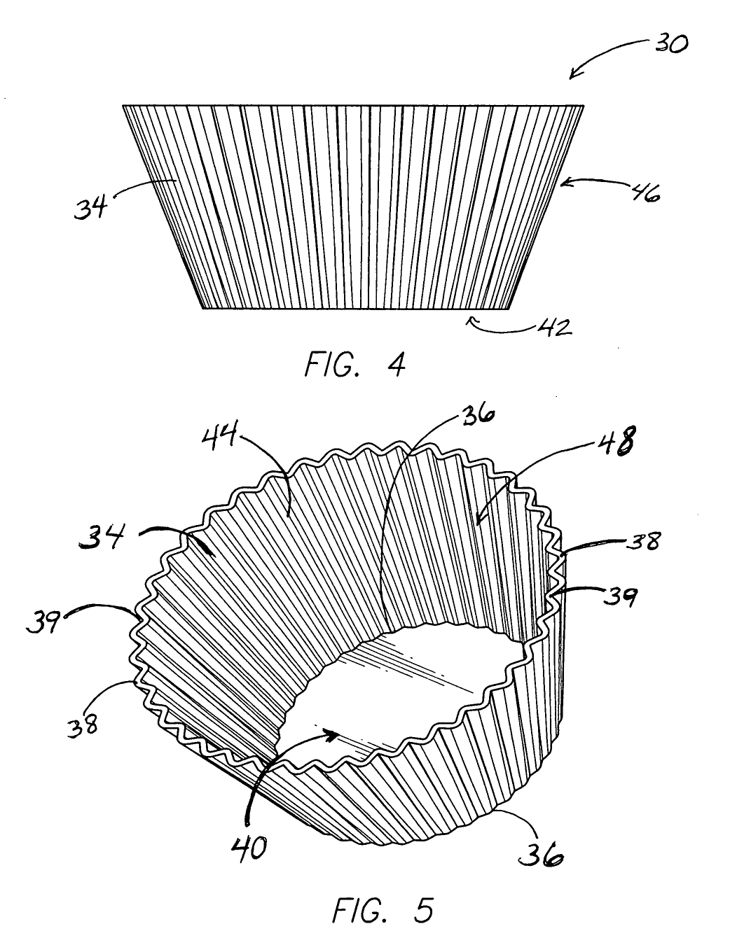

As shown in the FIGS. 1-5 for purposes of illustration, one embodiment of the present invention comprises a flexible, cupcake receptacle 30 having a body defining a cupcake batter receiving cavity 48 which is formed from a silicone rubber material. The body including a substantially planar base portion 32 and a substantially annular sidewall 34 extending upwardly and radially outwardly from the rounded periphery of the base portion 32. The annular side wall 34 and base portion 32 are preferably linked by an angular corner portion 36 along the rounded periphery of the base portion 32. The annular side wall preferably includes a plurality of radially outwardly extending ridges 38 and radially inwardly extending valleys 39. The substantially planar base portion 32 has an inner surface 40 and outer surface 42, and the annular side wall 34 has an inner surface 44 and outer surface 46. The inner surface 40 of the substantially planar base portion 32 and the inner surface 44 of the substantially annular sidewall portion 34 defining the surface of the cupcake batter receiving cavity 48.

Designs including ridges 38 and valleys 39 are preferred since, relative to smooth sidewall designs, they provide enhanced outward deformation of the sidewalls 34 after baking to assist in release of the cupcake from the receptacle. The ridges 38 and valleys 39 allow hinging along their length to assist in such deformation. However, it is contemplated that the receptacles of the invention could be manufactured with smaller ridges and valleys or without them, particularly where thinner side walls or more flexible silicone rubber materials are used to aid in product release. In such a receptacle, the sidewalls would be relatively smooth cross-section when viewed from above in a cross-section view similar to that shown in FIG. 2. As mentioned above, the invention is described with reference to “a cupcake receptacle.” However, it is intended that the term “cupcake receptacle” as used herein includes other, individual serving, substantially fruso-conical baked good receptacles such as muffin cups. It is also contemplated that receptacles of the invention can be used such as, e.g., food for products or materials other than baking batter. The receptacles of the invention are also well suited to act as a mold for making jello or as a serving receptacle to hold pudding, condiments, etc.

The receptacle 30 is preferably manufactures by conventional injection molding techniques with a vacuum assist in the mold cavity to ensure migration of the silicone evenly throughout the cavity. The preferred process parameters for forming the receptacles include a temperature of 375 degrees Fahrenheit, 4 cycles per minute, with a post forming cure time of 3 hours at 450 degrees Fahrenheit.

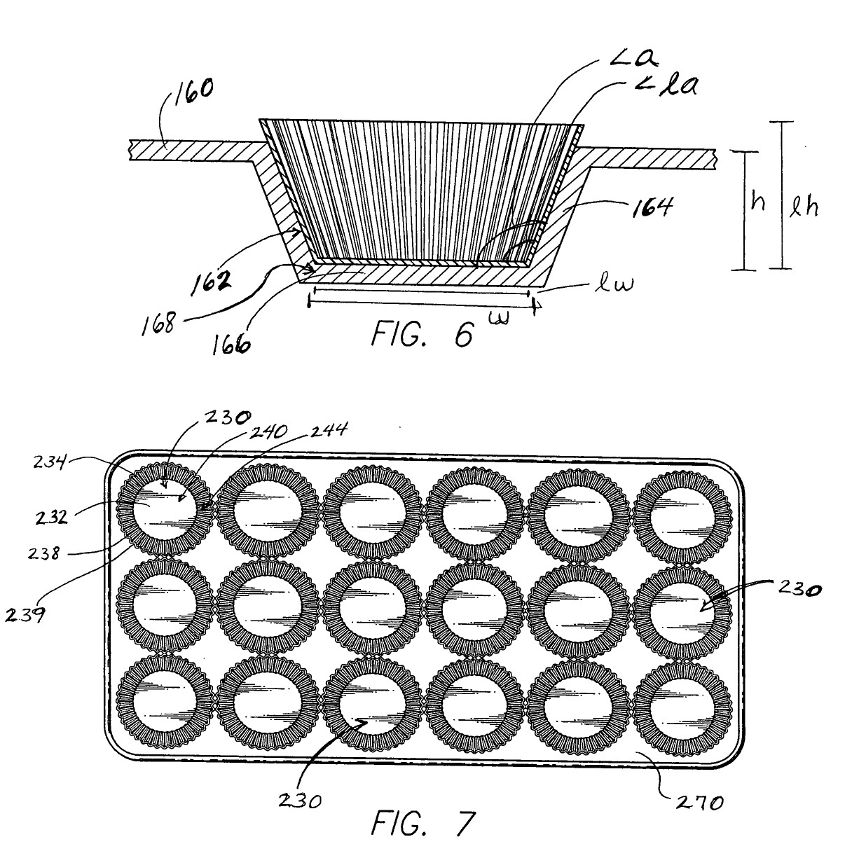

The preferred silicone rubber material is SILASTIC® 9280-70 produced by Dow Corning Corporation, Kendallive, Ind. 46755. However, other liquid silicone rubber materials that are food contact approved may be utilized. Preferably, such silicone rubber materials have a Shore A hardness of about 50 to about 70 (ASTM D2240), a modulus of elasticity of between about 3 MPa to about 6 MPa, with 3.9 MPa to 5.0 MPa being preferred (ASTM D412 DIE C), and a Bashore resilience of about 45 to about 65, with 58 being preferred (ASTM D2632). The preferred materials should also exceed the applicable food contact regulations such as FDA regulations 21 CFR 1.77, 2600 and BgVV, XV. The silicone rubber material selected should have sufficient rigidity that it can be filled with cupcake batter without substantially deforming, but also have sufficient elasticity that it can expand laterally after baking to assist in release of the cupcake from the receptacle cavity. With silicone rubber material such as SILASTIC® 9280-70, the preferred thickness of the side wall and base portion has been found to range between about 0.030 and about 0.060 of an inch, with about 0.040 of an inch preferred. This range is especially advantageous for embodiments of the invention such as those shown in FIG. 7 in which the receptacle of the invention is designed to be a cupcake mold, rather than merely a lining. In the embodiment of the invention in which the receptacle is designed for use as a cupcake lining, such as is shown in FIG. 6, the sidewalls and base portion may be thinner and the material may be softer and/or more elastic since the lining is intended to be supported by the cavity walls of the cupcake pan.

In one embodiment of the invention shown in FIG. 6, a receptacle of the invention may be a flexible cupcake liner 130 for lining a cavity 162 of a cupcake pan 160. In this embodiment of the invention, the cupcake pan preferably has a plurality of batter receiving cavities with predetermined dimensions for the bottom wall portion and sidewall portion that define the cavity 162. The flexible cup cake liners 130 of the invention may be made in a number of standard sizes that match the dimensions of the most common sizes of cavities in cupcake pans. Like the embodiment of the invention shown in FIGS.1-5, the liner 130 has a body defining a cupcake batter receiving cavity 148 which is formed substantially from a silicone rubber material. The body includes a substantially planar base portion 132 and a substantially annular sidewall 134 extending upwardly and radially outwardly from the rounded periphery of the base portion 132. The annular side wall 134 and base portion are preferably linked by an angular comer portion 136 along the rounded periphery of the base portion 132. The annular side wall preferably includes a plurality of radially outwardly extending ridges 138 and radially inwardly extending valleys 139. The substantially planar base portion 132 has an inner surface 140 and outer surface 142, and the annular side wall 134 has an inner surface 144 and outer surface 146. The inner surfaces 140 and 144 of the substantially planar base portion 132 and substantially annular sidewall portion 134 defining the surface of the cupcake batter receiving cavity 148 of the liner 130.

The cupcake pan 160 includes a frusto-conical pan cavity 162 defined by sidewall 164 and bottom 166. Typically, traditional cupcake pans include a limited number of standard sizes and shapes with standard sized and shaped batter cavities. For any given size, the height of the “h” of the sidewall 164 and width “w” of the bottom 166 are illustrated in FIG. 6. The measure of the angle “a” of the angled comer 168 is also typically limited to a standard number of angle measures. The liner 130 of the invention are thus selected to have a sidewall 134 with a height “lh” that is equal to or slightly larger than the height “h” of the sidewall 164 of the cupcake pan cavity 162. Width “lw” of the base portion 132 of the liner 130 is selected to be equal to or slightly smaller than the width “w” of the bottom 166 of the cupcake pans 160. Further, the measure of angle “a” which defined the angle at comer 136 of the liner 130 is selected to match or be slightly less than angle “a” of comer 168 of the cupcake pan 160. As mentioned above, the liner 130 may have a thinner base portion and side wall than the molds of the invention since the liner will be structurally supported by the bottom 166 and sidewall 164 of the cavity 162 of the cupcake pan 160. Typically, the thickness of the sidewalls 134 and base 132 of the liner 130 may vary between about 0.030 and about 0.060, with a thickness of about 0.040 being preferred.

In accordance with one embodiment of the invention shown in FIG. 7, a receptacle of the invention may be a resilient, individual cupcake mold 230 designed for receipt of cupcake batter and for baking without lateral support by the surfaces of a cupcake pan cavity. In this embodiment of the invention, each of a plurality of molds 230 preferably has a planar base portion 232 so that they can be easily arranged on a planar support 270. The planar support may be a shelf or rack formed within the baking oven, or preferably, may be a planar tray like article which is placed within and removed from the baking oven, such as a cookie sheet. As shown in FIG. 7 in accordance with one aspect of the invention, a plurality of molds 230 of the invention can be densely arranged on a planar support 270 prior to receipt of cupcake batter. The cupcake molds 230 may be placed immediately adjacent one another as illustrated in FIG. 7 or may even be in contact with one another. This arrangement allows the baker to maximize the number of cupcakes baked per batch without any deterioration in cupcake quality. This ability is a result of the excellent insulation and release properties of the silicone rubber material. Of course, the individual cupcake mold 230 could also be baked in smaller batches, or individually, if desired by the baker. In this embodiment of the invention, the molds 230 are not confined to the dimensions of standard sized cupcake pan (or muffin pan) cavities since they do not require lateral support. Accordingly, the molds 230 may be manufactured in a larger number of sizes and shapes to provide the baker with increased flexibility in baking cupcakes or muffins.

As mentioned above, the sidewalls 234 of the molds 230 should be of sufficient thickness to receive and hold the cupcake batter without substantial deformation of the sidewalls 234. Of course, the thickness of the sidewalls will vary based on the physical properties of the silicone rubber material selected with thicker walls required with a relatively soft, elastic silicone and thinner walls with harder, more rigid silicone. The annular side wall 234 and base portion 232 are preferably linked by an angled comer portion 236. The substantially planar base portion 232 has an inner surface 240 and outer surface (not shown), and the annular sidewall 234 has an inner surface 244 and outer surface (not shown). The inner surface 240 and 244 defining the surfaces of the cupcake batter receiving cavity 248.

In one aspect of the invention, an improved method of baking cupcakes is provided. The method includes filling a resilient, individual cupcake receptacle formed from a flexible, silicone rubber material with cupcake batter; placing the filled resilient, individual cupcake receptacle into an oven; baking the cupcake batter within the resilient, individual cupcake receptacle in an oven; removing the resilient, individual cupcake receptacle from the oven; and, flexing the resilient, individual cupcake receptacle to remove the baked cupcake therefrom. The receptacle may be either a mold or a liner in accordance with such a method. In one alternate method of the invention, the receptacle is a liner, such as liner 130, and the method further includes the step of placing the liner into the cavity of a cupcake pan prior to filling with batter.

Another embodiment of the invention constitutes an improved method of baking cupcakes. That method includes the steps of filling a resilient, individual cupcake mold formed from a flexible silicone material (such as mold 230) with cupcake batter. The filled resilient, individual cupcake mold is then placed into an oven and the cupcake batter is baked within the resilient, individual cupcake mold. The resilient, individual cupcake mold is removed from the oven and after cooling. The resilient, individual cupcake mold is then flexed to remove the baked cupcake therefrom. Preferably, the flexing is accomplished by pushing and pulling at the sidewall 234 of the mold 236. The hinge lines provided by the ridge 238 and valley 239 of the sidewall assist in providing “hinge-like” structures which allows additional flexing of the sidewall 234. It is also preferred that the method further includes the step of cleaning the mold 230 in a conventional dishwasher and reusing it to make additional cupcakes.

Another alternate method of the invention involved baking a plurality of cupcakes in individual, resilient silicone cupcake molds. The method includes the steps of filling a plurality of resilient, individual cupcake molds formed from a flexible silicone resin with cupcake batter; placing each of the filled resilient, individual cupcake molds onto a substantially planar support surface; baking the cupcake batter within the plurality of resilient, individual cupcake molds in an oven; removing the plurality of resilient, individual cupcake molds from the oven; and flexing each of the resilient, individual, cupcake molds to remove the baked cupcake therefrom. An alternate method of this embodiment includes the further steps of densely spacing the plurality of resilient individual cupcake molds onto a planar support surface such that the cupcake molds are adjacent to other of the plurality of resilient, individual cupcake molds. The resilient, individual cupcake molds may even be placed in contact with the adjacent cupcake molds. In accordance with this method which is illustrated, in part, in FIG. 7, it has been found that number of cupcakes per batch can be maximized without any loss in quality of the resulting cupcakes. In still another alternate of this method, a single, individual, cupcake may be baked in accordance with the invention.

It will be appreciated that although various aspects of the invention have been described and illustrated with respect to specific embodiments, alternatives and modifications will be apparent from the present disclosure, which are within the scope of the present invention as set forth in the following claims.

1. An improved receptacle for receipt of a single serving food product comprising:
a body portion defining a single serving receiving cavity formed substantially from a silicone rubber material, the body portion including,
a substantially planar base portion having a rounded periphery, the base portion having an inside surface for receipt of food product and an outside surface for contacting a support; and
a resilient, substantially annular sidewall portion which extends upwardly and radially outwardly from the rounded periphery of the planar base portion, the annular sidewall portion having an inner surface for receipt of food product.

2. The improved receptacle of claim 1 wherein the substantially annular sidewall and the planar base portion are joined by an angled corner portion.

3. The improved receptacle of claim 1 wherein the substantially annular sidewall includes a plurality of ridges extending radially outwardly and valleys extending radially inwardly, the plurality of ridges and valleys cooperating to enhance the flexibility of the substantially annular side wall.

4. The improved receptacle for receipt of batter of claim 1 wherein the frusto-concial body is injection molded from a flowable silicone rubber material.

5. The improved receptacle of claim 1 wherein the planar bottom portion and substantially annular sidewalls are dimensioned to fit within a frusto-conical depression in a cupcake pan to serve as a cupcake liner.

6. The improved receptacle of claim 1 wherein the planar bottom portion and substantially annular sidewalls are formed from a sufficiently thick layer of silicone rubber to impart sufficient rigidity to resist substantial deformation when cupcake batter is received therein so that the receptacle can act as a cupcake mold for baking without additional lateral support.

7. The improved receptacle of claim 1 wherein the base portion has an inside surface for receipt of muffin batter.

8. An improved cupcake liner for insertion within a cupcake pan having a plurality of batter receiving cavities with bottom and sidewalls of predetermined dimensions, the cupcake liner comprising:
a frusto-conical body formed substantially from a silicone resin, the body including,
a planar base portion having a rounded periphery and being dimensioned for receipt within the bottom of the batter receiving cavities of the cupcake pan; and
a substantially annular sidewall portion which extends upwardly and radially outwardly from the rounded periphery of the planar base portion, the substantially annular sidewall being dimensioned for lining the sidewalls of the batter receiving cavities.

9. The improved cupcake liner of claim 8 wherein the substantially annular sidewall and the planar base portion are joined by an angled corner portion.

10. The improved cupcake liner of claim 8 wherein the substantially annular sidewall includes a plurality of ridges extending radially outwardly and valleys extending radially inwardly, the plurality of ridges and valleys cooperating to enhance the flexibility of the substantially annular side wall.

11. The improved cupcake liner of claim 8 wherein the fusto-concial body is injection molded from a flowable silicone rubber material.

12. An individual cupcake mold for receiving cupcake batter:
a frusto-conical body formed substantially from a silicone resin, the frusto-conical body including,
a planar base portion having a rounded periphery, the base portion having an inside surface for receipt of cupcake batter and an outside surface for contacting a support; and
a substantially annular sidewall portion which extends upwardly and radially outwardly from the rounded periphery of the planar base portion, the planar bottom portion and substantially annular sidewalls are formed from a sufficiently thick layer of silicone rubber to impart rigidity sufficient to resist substantial deformation when cupcake batter is received therein so that the receptacle can act as a stand alone cupcake mold for baking.

13. The improved individual cupcake mold of claim 12 wherein the substantially annular sidewall and the planar base portion are joined by an angled corner portion.

14. The improved individual cupcake mold of claim 12 wherein the substantially annular sidewall includes a plurality of ridges extending radially outwardly and valleys extending radially inwardly, the plurality of ridges and valleys cooperating to enhance the flexibility of the substantially annular side wall.

15. The improved individual cupcake mold of claim 12 wherein the fusto-concial body is injection molded from a flowable silicone rubber material.

16. An improved method of baking cupcakes comprising the steps of:
filling an resilient, individual cupcake receptacle formed from a flexible silicone resin with cupcake batter;
placing the filled resilient, individual cupcake receptacle into an oven;
baking the cupcake batter within the resilient, individual cupcake receptacle in an oven;
removing the resilient, individual cupcake receptacle from the oven; and,
flexing the resilient individual, resilient cupcake receptacle to remove the baked cupcake therefrom.

17. The method of claim 16 further including the steps of washing the resilient individual, cupcake receptacle and reusing the resilient individual, cupcake to once again receive cupcake batter for baking at least one additional cupcake.

18. The method of claim 16 wherein the cupcake receptacle is a cupcake liner and, wherein the method further includes the step of placing the cupcake liner within a batter receiving cavity of a cupcake pan prior to filling with cupcake batter.

19. The method of claim 16 wherein the cupcake receptacle is a cupcake mold and, wherein the method further includes the steps of placing the cupcake mold on to a substantially planar support surface prior to placing the cupcake mold in the oven.

20. An improved method of baking a plurality of cupcakes in a plurality of resilient silicone cupcake molds comprising the steps of:
filling a plurality of resilient, individual cupcake molds formed from a flexible silicone rubber material with cupcake batter;
placing each of the filled resilient, individual cupcake molds onto a planar support surface;
baking the cupcake batter within the plurality of resilient, individual cupcake molds in an oven;
removing the plurality of resilient individual cupcake molds from the oven; and
flexing each of the resilient individual, cupcake molds to remove the baked cupcake therefrom.

21. A method in accordance with claim 20 further including the steps of densely spacing the plurality of resilient, individual cupcake molds onto a planar support surface adjacent to another of the plurality of resilient, individual cupcake molds.
